(19) United States
(12) Patent Application Publication
(10) Pub. No.: US 2026/0361110 A1
(43) Pub. Date: Nov. 12, 2026

(54) BYPASS ENABLED FURNITURE BATTERY PACK

(71) Applicant: Era Nouveau, LLC, Redondo Beach, CA (US)

(72) Inventors: Thomas Justin Peper, Redondo Beach, CA (US); John S. Contreras, Redondo Beach, CA (US)

(73) Assignee: Era Nouveau, LLC, Redondo Beach, CA (US)

(21) Appl. No.: 19/669,891

(22) Filed: May 6, 2026

Related U.S. Application Data
(60) Provisional application No. 63/801,537, filed on May 7, 2025.

(51) Int. Cl. H02J 7/00; H02J 7/80; H02J 7/90

(52) U.S. Cl. CPC H02J 7/855; H02J 7/80; H02J 7/865; H02J 7/975

(57) ABSTRACT

A battery pack and power management system for powered furniture includes a rechargeable battery, a power input configured to receive power from an external power source, a power output configured to supply one or more furniture loads, a bypass path between the power input and the power output, and control circuitry configured to selectively enable charging, disable discharging, and route power through the bypass path based on battery state-of-charge thresholds and adapter presence. When external power is available, the furniture load is preferentially powered from the external power source while battery discharge is inhibited. When the battery state of charge is below a recharge threshold, surplus external power may charge the battery until an upper charge threshold is reached. Once the upper charge threshold is reached, charging is disabled and the battery enters a dormant monitored state.

### CROSS-REFERENCE TO RELATED APPLICATIONS

This application claims the benefit of prior application U.S. Provisional Application No. 63/801,537, filed May 7, 2025, titled “BYPASS ENABLED FURNITURE BATTERY PACK,” which is herein incorporated by reference in its entirety for all purposes.

### TECHNICAL FIELD

The present disclosure relates generally to battery packs, more specifically to furniture-operating battery packs.

### BACKGROUND

Traditionally, furniture has largely been immobile or manually operated. Only recently has furniture become motorized. However, motorized functions on furniture (e.g. reclining) are often battery-operated. Unfortunately, furniture is built to utilize existing batteries, which are not designed specifically for the operation of motorized furniture and which present a variety of limitations.

The integration of electronic devices and functionalities into furniture has increased significantly in recent years. Features such as embedded charging stations, adjustable lumbar support, integrated lighting, and motorized reclining mechanisms enhance user comfort and convenience. However, a significant limitation of current smart furniture is the reliance on batteries with relatively short lifespans. Frequent battery replacement or recharging cycles disrupts the user experience, adds maintenance burdens, and contributes to electronic waste.

Conventional furniture battery packs often operate as pass-through supplies in which current from an external adapter flows through battery-associated circuitry before reaching a furniture load. Such arrangements may expose battery cells to unnecessary cycling, heat, parasitic drain, or simultaneous charge/discharge conditions. These operating conditions can reduce battery life, increase thermal risk, and create inefficient power delivery during normal use when wall power is available. Existing systems also typically fail to prioritize direct load power independently from battery charging based on battery state-of-charge thresholds. Therefore, there exists a need for improved power solutions, including longer-lasting batteries and more efficient power management systems, to enhance the practicality and user-friendliness of electronically enhanced furniture.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

Aspects of the present disclosure relate to systems and methods for powering motorized furniture. One aspect relates to a battery pack to be used in motorized furniture. The battery pack includes a motherboard for regulating the charge of the battery up to a certain threshold. The battery pack is configured in a way such that while motorized furniture and the battery pack are connected to a constant external power source, the motorized furniture draws power directly from the external power source, thereby bypassing the battery pack altogether, when the battery pack is charged to a certain threshold level. When the battery pack is charged to below the certain threshold level, the system prioritizes powering the motorized furniture directly and then charges the battery using any leftover charge available.

In some embodiments, the battery pack includes a power input configured to receive power from an external adapter, a power output configured to supply power to one or more powered furniture loads, a rechargeable cell stack, a charge control switch, a discharge control switch, a bypass path electrically coupled between the power input and the power output, and a controller configured to selectively control the charge control switch and the discharge control switch based at least in part on detected adapter presence, cell voltage, battery state of charge, load demand, temperature, or combinations thereof.

In some embodiments, when the external adapter is present, the controller disables battery discharge and routes adapter power to the furniture load through the bypass path. When the battery state of charge is below a recharge threshold, surplus adapter power not required by the furniture load is supplied to the battery through the charge control switch. When the battery reaches an upper charge threshold, the controller disables further charging and maintains the battery in a dormant or non-discharging state while the furniture load remains powered from the external adapter.

In some embodiments, the upper charge threshold corresponds to less than a full chemical capacity of the battery, such as approximately 80% of total cell capacity, while being represented to a user as 100% usable capacity. In some embodiments, a lower recharge threshold is approximately 60% usable capacity. Other threshold values, threshold ranges, voltage-based thresholds, coulomb-counted thresholds, temperature-adjusted thresholds, or chemistry-specific thresholds may be used.

These and other embodiments are described further below with reference to the figures.

### BRIEF DESCRIPTION OF THE DRAWINGS

The disclosure may best be understood by reference to the following description taken in conjunction with the accompanying drawings, which illustrate particular embodiments of the present disclosure.

FIG. 1A illustrates one perspective view of an example battery pack, in accordance with some embodiments.

FIG. 1B illustrates another perspective view of an example battery pack, in accordance with some embodiments.

FIG. 2A illustrates a block diagram of system components, in accordance with some embodiments.

FIG. 2B illustrates another block diagram of system components, in accordance with some embodiments.

FIG. 2C illustrates another block diagram of system components, in accordance with some embodiments.

FIG. 2D illustrates another block diagram of system components, in accordance with some embodiments.

FIG. 3A illustrates one side of an example regulatory motherboard, in accordance with some embodiments.

FIG. 3B illustrates another side of an example regulatory motherboard, in accordance with some embodiments.

FIG. 4A illustrates an example of signal conditions for component lines, in accordance with some embodiments.

FIG. 4B illustrates another example of signal conditions for component lines, in accordance with some embodiments.

FIG. 5A illustrates an example analog front end, in accordance with some embodiments.

FIG. 5B illustrates an example MCU, in accordance with some embodiments.

FIG. 5C illustrates an example charge management, in accordance with some embodiments.

FIG. 5D illustrates an example circuit connection diagram, in accordance with some embodiments.

FIG. 6 illustrates an example method, in accordance with some embodiments.

FIG. 7 illustrates a block diagram of an example power path architecture, in accordance with some embodiments.

FIG. 8 illustrates an example state diagram for power management control, in accordance with some embodiments.

FIG. 9 illustrates an example charge and discharge profile showing threshold-based hysteresis behavior, in accordance with some embodiments.

FIGS. 10A-10C illustrate an example of motorized furniture functions, in accordance with some embodiments.

FIG. 11 illustrates an example computer system, in accordance with some embodiments.

### DETAILED DESCRIPTION OF PARTICULAR EMBODIMENTS

Reference will now be made in detail to some specific examples of the present disclosure including the best modes contemplated by the inventors for carrying out the present disclosure. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, the techniques of the present disclosure may be described in the context of furniture. However, it should be noted that the techniques of the present disclosure may apply to various other systems, such as medical systems or other battery-powered systems. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

As used herein, “bypass” or “bypass path” refers to an electrical path by which power from an external power source is delivered to a furniture load without requiring discharge current from the battery cells. A bypass path may include one or more diodes, ideal-diode controllers, MOSFETs, relays, power multiplexers, load switches, current-limiting devices, or combinations thereof.

As used herein, “motherboard,” “regulatory motherboard,” “control board,” or “battery management board” may refer to one or more printed circuit boards, flexible circuits, integrated circuits, controllers, processors, analog front ends, battery management systems, protection circuits, firmware-executing devices, or combinations thereof.

As used herein, “adapter” and “external power source” will be used interchangeably even though an adapter receives power from an external power source.

As used herein, “state of charge” may be determined by voltage measurement, average cell voltage, coulomb counting, impedance estimation, open-circuit voltage, learned battery behavior, temperature-compensated calculations, or combinations thereof.

Numerical values described herein are examples unless expressly stated otherwise. Thresholds such as 80%, 60%, 25%, 10%, 35° C., 1 ampere, 37 mA, and 14 µA may vary by battery chemistry, cell count, adapter rating, load type, safety certification requirement, or firmware configuration.

### Overview

The techniques and mechanisms of the present disclosure provide a novel battery management system for powered furniture, designed to maximize battery lifespan and energy efficiency. According to various embodiments, the system employs firmware/motherboard control to limit charging to 80% of total capacity (100% usable capacity) and features an auto-charge function that engages when the battery reaches 60% usable capacity. In one example, the upper charge threshold corresponds to approximately 80% of total cell capacity and is displayed or treated by the system as 100% usable capacity. Limiting charging below full chemical capacity may reduce cell stress, heat generation, and degradation. In some embodiments, the upper charge threshold is enforced by firmware, hardware, or both. In some embodiments, the upper charge threshold may be selectively adjusted for shipping mode, storage mode, calibration, service diagnostics, cell chemistry, temperature, or regulatory compliance. In some embodiments, a hardware gate prioritizes wall power over battery power, ensuring efficient energy usage and preventing simultaneous charging and discharging. In some embodiments, the system also addresses key differentiation points from backup generator and solar power systems.

### Example Embodiments

As mentioned above, powered furniture increasingly incorporates batteries to provide enhanced functionality, such as adjustable positions, massage features, and integrated electronics. Efficient battery management is crucial to optimize performance, extend battery life, and minimize energy consumption. Thus, the techniques and mechanisms of the present disclosure provide for an improved system designed to address these challenges.

According to various embodiments, the battery management system operates under the following principles: limited charging capacity, automatic recharging, prioritized wall power, efficient power distribution, optimized charging, and dormant state.

Limited Charging Capacity: According to various embodiments, the battery is charged to a maximum of 80% of its total capacity, which corresponds to 100% of the usable capacity. In some embodiments, this strategy, controlled by firmware/motherboard, is known to prolong battery lifespan, similar to battery management systems implemented in other devices. In some embodiments, this means that from the user perspective, the battery is fully charged when the actual capacity is 80%, or some other predefined upper limit threshold, meaning it is not possible to charge the battery past 80%, or the predefined upper limit threshold, under any circumstance. In such embodiments, this means there is a “hardware” limit to prevent the charging of the battery past 80% capacity. In some embodiments, the upper charge threshold may be selectively adjusted for shipping mode, storage mode, calibration, service diagnostics, cell chemistry, temperature, or regulatory compliance. Limiting charging below full chemical capacity may reduce cell stress, heat generation, and degradation. In some embodiments, the upper charge threshold is enforced by firmware, hardware, or both.

Automatic Recharging: According to various embodiments, when the battery state of charge decreases to or below a recharge threshold, the system automatically initiates a recharge cycle when external power is available. In one example, the recharge threshold corresponds to approximately 60% usable capacity. The difference between the recharge threshold and the upper charge threshold provides hysteresis that prevents frequent charge toggling. The recharge threshold may be determined using remaining voltage, average cell voltage, cell stack voltage, coulomb counting, load-adjusted voltage, temperature-compensated voltage, or combinations thereof.

Prioritized Wall Power: According to various embodiments, a hardware gate ensures that wall power is the primary power source for the furniture. In some embodiments, when an external power source is detected, the system completely bypasses the battery to power the furniture. If wall power is unavailable, the system switches to battery power. This is different from most current battery systems that prioritize charging of the battery when an external power source is detected. In addition, in current systems, a current runs from an external source through the battery in order to power the device. By contrast, the techniques and mechanisms of the present disclosure provide for a circuit configuration that completely bypasses the battery under certain battery conditions, not a pass-through mechanism, to power the device.

In some embodiments, the bypass path includes a diode arranged to allow current flow from the external adapter toward the furniture load while blocking reverse current flow from the battery toward the adapter. In other embodiments, the bypass path includes an ideal diode circuit, an active MOSFET bypass circuit, a relay, a power multiplexer, a load-sharing controller, or a power-path management circuit. The controller may disable the discharge MOSFET when adapter presence is detected so that load current is supplied preferentially from the external adapter instead of from the battery cells.

In some embodiments, the bypass operation is different from pass-through battery operation because load current does not require battery cell discharge while the adapter is available and the discharge path is disabled. The battery may therefore remain electrically isolated from the load, except during controlled charging or diagnostic measurement.

Efficient Power Distribution: According to various embodiments, when an external adapter is connected, adapter power is prioritized for the furniture load. If the furniture load demand is less than available adapter capacity and the battery state of charge is below the upper charge threshold, surplus adapter capacity may be used to charge the battery through a controlled charge path. In this configuration, the battery is not used as the discharge source for the furniture load while the external adapter is present and the bypass path is active.

Optimized Charging: According to various embodiments, the battery is charged based on availability of external power and system operating conditions rather than continuous or unconditional charging. In some embodiments, when an external power source is present, electrical energy is first supplied to the furniture load via a bypass path. If the power demand of the furniture load is less than the available external power, surplus power is used to charge the battery. Charging may occur when the battery state of charge is below an upper charge threshold and may be inhibited when the battery reaches the upper charge threshold. In this manner, charging is conditionally prioritized based on load demand and battery state rather than simply initiating charging whenever an external power source is connected.

Dormant State: According to various embodiments, once the battery reaches the upper charge threshold, the controller disables the charge path, disables or maintains disabled the discharge path when external power remains available, and monitors one or more battery parameters while preventing further charging. In this dormant state, the battery cells are not used to supply the furniture load and are not actively charged, although monitoring, protection, communication, or user-interface circuitry may remain powered at a low current level. In some embodiments, once the battery reaches 100% usable capacity (80% total battery capacity), it is turned off/made dormant by firmware. In such embodiments, in this state, there is no passthrough current through the battery and the battery no longer charges past this threshold.

The techniques and mechanisms of the present disclosure provide for many advantages over current systems, such as backup generators, standard battery packs, and solar powered walls. Regarding backup generators, one key differentiation is that techniques and mechanisms of the present disclosure provide a system that is integrated into the furniture's primary power management. This essentially optimizes energy use and extends battery life. By contrast, a backup generator provides power only during a power outage. Regarding standard battery packs and solar powered walls, one key differentiator is that solar powered walls generate power, and this system manages the distribution and storage of power. The crucial difference is how the system manages the power: it doesn't simply split the charge; it prioritizes power delivery to the furniture and uses surplus energy to charge the battery, thereby optimizing for the furniture's operation. Few, if any, conventional battery systems incorporate such a power prioritization distribution.

The techniques and mechanisms of the present disclosure provide for a battery management system for powered furniture that offers several advantages, including extended battery life, efficient energy consumption, and seamless power source transition. According to various embodiments, the system's design, which prioritizes direct power from the wall and optimizes battery charging, represents a significant improvement over existing power solutions.

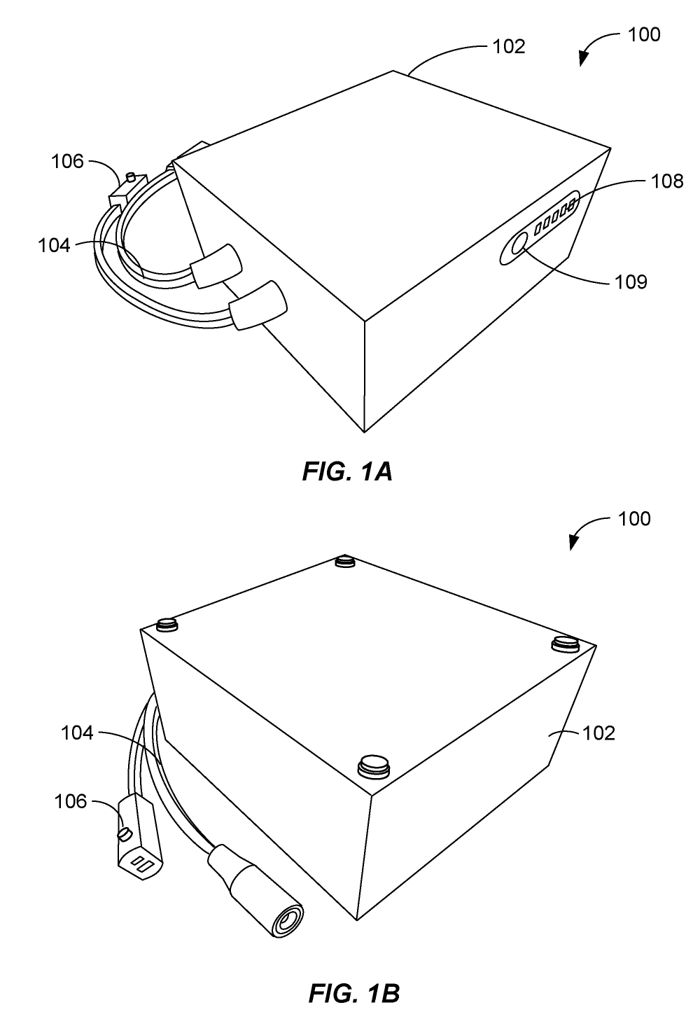

FIG. 1A illustrates a top perspective view of an example battery pack. Battery pack 100 includes an outer case, or body, 102, external LED display 108 with a power button 109, a charging cable 104 (input), and an output cable 106. In some embodiments, outer case 102 comprises a high density, heat resistant plastic. In some embodiments, power button 109, when pushed, causes LED lights 108 to display how much battery life is left. FIG. 1B illustrates a bottom perspective view of battery pack 100.

Charging cable 104 and output cable 106 may be implemented as barrel connectors, keyed connectors, locking connectors, magnetic connectors, multi-pin connectors, USB-C power connectors, or other suitable power connectors. In some embodiments, the input and output connectors are physically keyed or electrically protected to prevent reverse connection. Battery pack 100 may be removably coupled to furniture 700, mounted inside a furniture frame, positioned beneath a seat base, or integrated into a furniture power module.

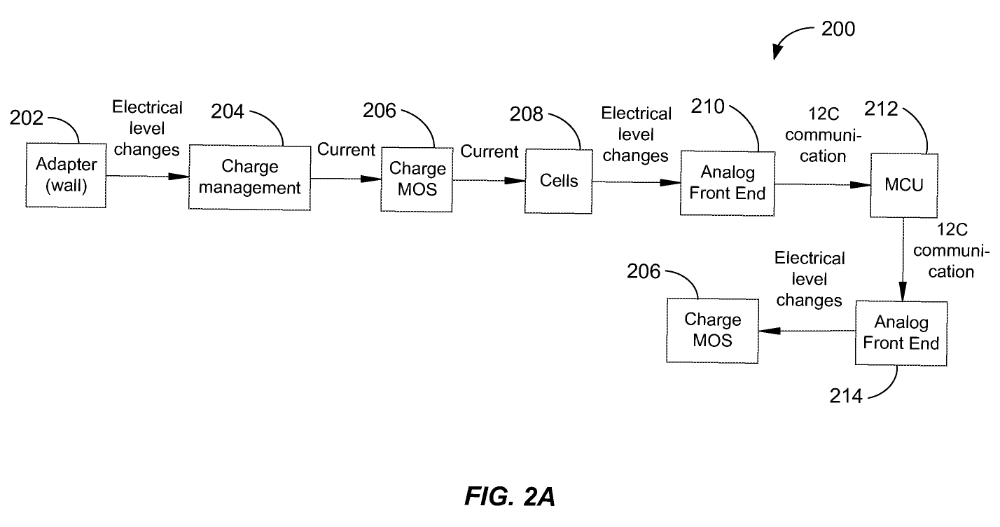

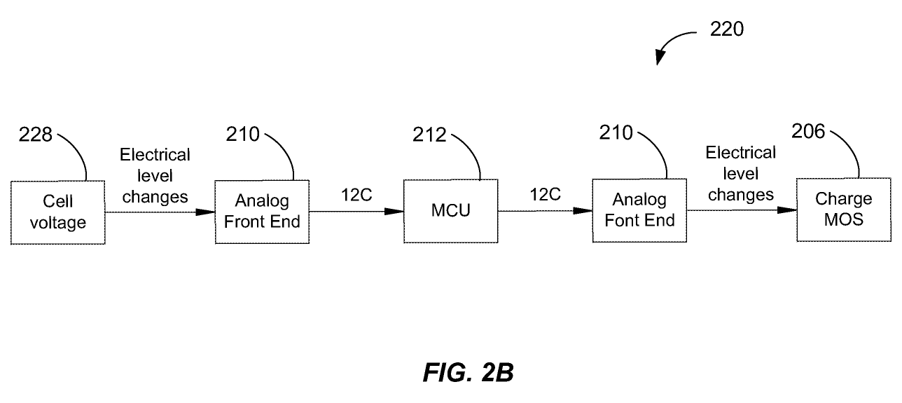

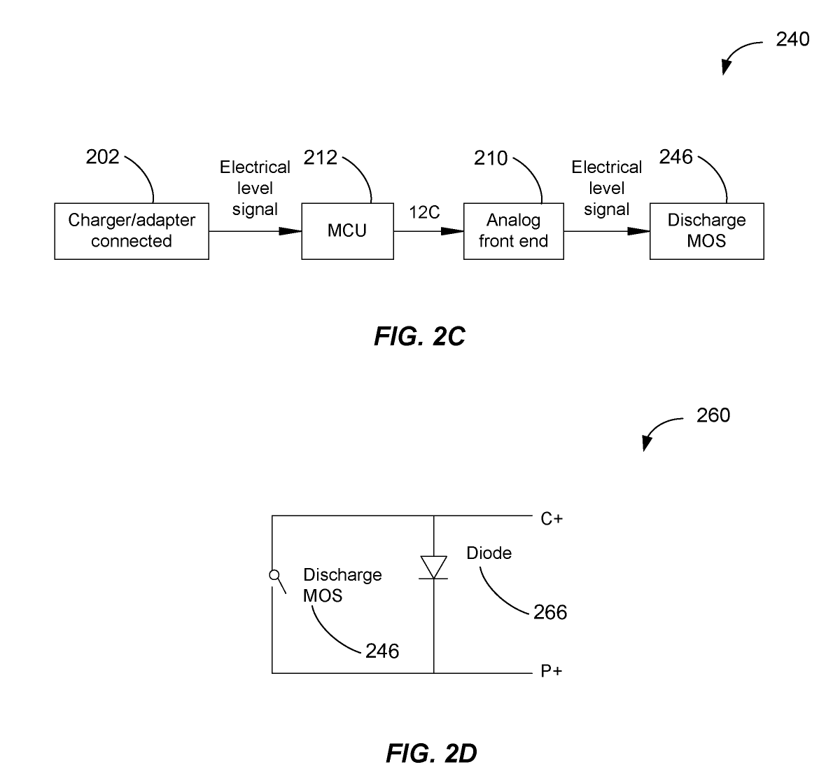

FIG. 2A illustrates a block diagram 200 of system components, in accordance with some embodiments. Block diagram 200 represents just one example embodiment of the possible components used in a battery charging cycle. Other embodiments may include only a subset of the components described in FIG. 2A, and some embodiments may even include additional components not mentioned.

In reference to block diagram 200, upon connecting the AC-DC adapter 202 (which is also connected to an external power source on wall) to the battery's charging port, electrical energy is directed through an integrated circuit designated for charge management 204. In some embodiments, this component regulates the charging current using a charge metal-oxide-semiconductor field-effect transistor (MOSFET) 206, ensuring it does not exceed a value of one ampere. In some embodiments, when charge MOSFET 206 is active, battery cells 208 are charging. Concurrently, during the battery charging cycle, an analog front-end circuit 210 acquires the average voltage of the battery cells 208 and transmits this data to the microcontroller unit (MCU) 212. Once the MCU 212 registers that the average voltage has attained eighty percent of its full capacity, analog front-end circuit 210 signals the MOSFET 206 to be deactivated, thereby terminating the charging process.

FIG. 2B illustrates another block diagram 220 of system components, in accordance with some embodiments. As with block 200, block diagram 220 represents just one example embodiment of the possible components used in a battery charging cycle. Other embodiments may include only a subset of the components described in FIG. 2B, and some embodiments may even include additional components not mentioned.

In reference to block 220, upon the battery reaching eighty percent of its charge capacity, the MCU 212 will deactivate charge MOSFET 206, thereby ceasing the charging process. Subsequently, when the battery cell voltage 228 diminishes to low-end threshold voltage, e.g., sixty percent, analog front-end circuit 210 will transmit the voltage data to MCU 212. In response, MCU 212 will reactivate charge MOSFET 206, facilitated by the control signals from analog front end 210, thereby enabling the battery to be recharged.

FIG. 2C and 2D illustrate another block diagram 240 of system components, in accordance with some embodiments. As with block 200, block diagram 240 represents just one example embodiment of the possible components used in a battery charging cycle. Other embodiments may include only a subset of the components described in FIG. 2C, and some embodiments may even include additional components not mentioned.

In reference to block diagram 240, the battery system incorporates a pre-established charging priority. Upon the MCU 212 detecting the connection of a charger or adapter 202 to the battery, MCU 212 will deactivate a discharge MOSFET 246 via the analog front end 210, thereby inhibiting battery discharge. Concurrently, at this juncture, the current supplied by the AC-DC adapter 202 will bypass the battery through a parallel diode 266, as shown in FIG. 2D, and directly provide power to the furniture, e.g., a massage chair, a sofa, or a bed. This is in direct contrast to conventional battery systems that have pass through current when an AC-DC adapter is connected to an external power source. The bypass circuity 260 results in an drastic improvement over conventional pass through circuitry because, in contrast to conventional pass-through battery systems in which current from an external power source flows through the battery to power a load, the systems described herein provide a bypass path that allows the external power source to directly power the load while electrically isolating the battery from the discharge path. This configuration reduces battery cycling, improves energy efficiency, minimizes heat generation, and prevents simultaneous charging and discharging of the battery. Additionally, by prioritizing delivery of power to the load and only charging the battery using surplus power, the system provides improved power management and extended battery lifespan.

In some embodiments, the controller operates according to a plurality of power states including: an adapter-present/load-bypass state, an adapter-present/charge-enabled state, an adapter-present/charge-disabled dormant state, an adapter-absent/battery-discharge state, a low-battery alert state, a thermal-protection state, and a fault-isolation state. Transitions between the states may be based on adapter detection, measured cell voltage, battery state of charge, load current, charge current, temperature, elapsed time, user input, wireless command, or fault detection.

In some embodiments, adapter presence is detected by sensing voltage at an input terminal, current through an input path, a logic signal from a charger-management circuit, or a signal from a power-path controller. In response to detecting adapter presence, the MCU may command the analog front end to open the discharge MOSFET and may allow adapter current to flow to the furniture load through the bypass path.

In some embodiments, the exchange of information between the microcontroller unit (MCU) and the analog front end is facilitated by Inter-Integrated Circuit (I2C) communication. The subsequent paragraphs delineate the operational characteristics of this communication protocol.

In some embodiments, the Serial Data Line (SDA) serves as the bidirectional conduit for the transmission of serial data between interconnected devices. The Serial Clock Line (SCL) is responsible for the generation of synchronous clock pulses, which govern the timing of data transfer.

In some embodiments, both the SCL and SDA lines constitute the signal pathways of the I2C bus. The I2C bus operates as a shared multi-master system, enabling the connection of multiple I2C-compliant devices. Devices connected to the I2C bus can function as either a master or a slave. The master device assumes control over the communication, initiating and terminating data transmission and generating the synchronous clock pulses. Conversely, slave devices remain in a passive state, awaiting commands from the master. Notably, the synchronous clock signal is exclusively generated by the master device.

In some embodiments, in an idle state, when no communication is in progress, both the SDA and SCL lines are held at a high electrical level. To initiate communication with a specific slave device, the master device transmits a start condition, followed by the slave device's address and a read/write control bit. Upon completion of data transmission, the master device issues a stop condition. Data is transmitted in byte-sized segments, each comprising eight bits transferred from the most significant bit to the least significant bit. (The SDA line provides bidirectional data transfer, while the SCL line carries the clock signal, synchronizing data transfer across the I2C bus. The master device initiates communication by sending the start signal. This signal is characterized by a transition of the SDA line from a high to a low electrical level while the SCL line is held high. Subsequently, the master device transmits data bytes. The master device concludes the transmission by sending a stop signal, which involves a transition of the SDA line from a low to a high electrical level while the SCL line is high.)

In some embodiments, the start signal is defined by a high-to-low transition on the SDA line while the SCL line remains at a high electrical level, signifying the commencement of data transmission. During data transmission, the electrical level of the SDA line can only be altered when the SCL line is in a low electrical state.

Although I2C communication is described as one example, communication betweedule, sensors, or display circuitry may alternatively use SPI, UART, SMBus, CAN, LIN, one-wire communication, GPIO signaling, analog signaling, pulse-width mon the MCU, analog front end, charger-management circuit, memory, wireless modulation, or another wired or wireless communication protocol.

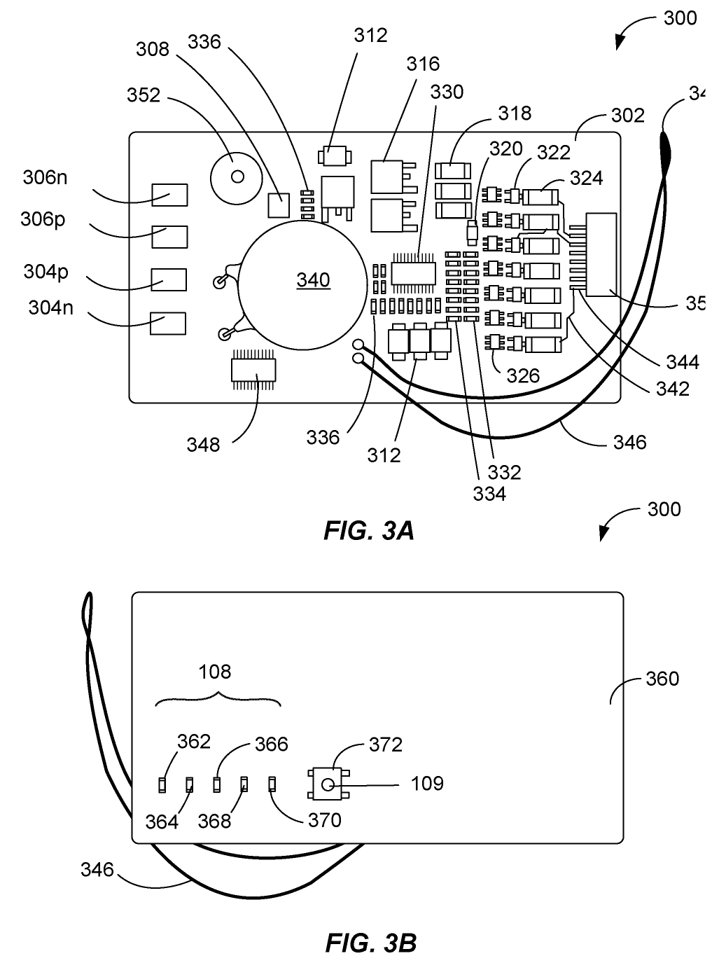

FIG. 3A illustrates a frontside view of example regulatory motherboard 300. Motherboard 300 is responsible for monitoring and regulating the charging and discharging of the cells. In addition, motherboard 300 is responsible for most of the functions of battery pack 100. Further, motherboard 300 may enforce an upper charge threshold by causing the charge-management circuitry and/or user-interface circuitry to treat the battery as fully charged when the measured battery condition corresponds to less than the full chemical capacity of the battery. In some embodiments, motherboard 300 can comprise a printed circuit board (PCB) motherboard. Motherboard 300 includes a non-conductive base 302 and trace wires 342 printed on base 302 that make up the circuit of motherboard 300.

According to various embodiments, motherboard 300 includes processor 330 for performing all the board’s functions. Processor 330 acts as the brain of the board. It is a programmable chip programmed to work with all of the battery pack functions, charging, discharging, safety regulation, monitoring the temperature, LED light display and function, and communicates with Bluetooth processor 348. Processor 330 basically controls all functions of motherboard 330 and works with all the elements described below to implement the functions of battery pack 100. The elements described below, with the exception of processors, are simply elements that assist processor 330 with the functions described attributed to the elements. In addition, even the other processors, 348 and 308, are in communication and work with processor 330. In some embodiments, processor 330 is responsible for turning off the output when the battery pack is charging. In some embodiments, this may be important because the batteries are more volatile as they are charging. Thus, turning off usage while the battery is charging is safer.

The functions attributed to processor 330 may be performed by one or more microcontrollers, microprocessors, application-specific integrated circuits, battery-management integrated circuits, analog control circuits, programmable logic devices, discrete logic components, or combinations thereof. In some embodiments, certain protection functions are implemented independently of processor 330 so that over-current, over-voltage, under-voltage, short-circuit, or over-temperature protection remains available even during processor reset or firmware failure.

In some embodiments, on one side of motherboard 300 sits four wire connection points 306n, 306p, 304p, and 304n. These connection points electrically connect current wires 106n, 106p, 104p, and 104n to motherboard 300. In some embodiments, the connection points are soldering points because the wires are soldered onto the motherboard. In some embodiments, the connection points are welding points, because the wires are welded, via either tack welding or spot welding, to motherboard 300. In some embodiments, if the wires are soldered, then an extra protective layer comprising an insulating material, such as silicone or rubber cement, should be applied to the solder points to prevent solder balls from moving, thereby immobilizing them and preventing them from becoming a potential hazard or shorting the circuit. In some embodiments, welding is preferred because of the possibility of solder balls forming during soldering. As described herein, any connection points disclosed can be done with either soldering or welding, depending on preference.

In some embodiments, the connection points include strain relief, potting material, conformal coating, insulating barriers, fuses, resettable fuses, reverse-polarity protection, or keyed connector structures. These features may reduce mechanical fatigue, short-circuit risk, moisture intrusion, or incorrect connection during assembly or service.

In some embodiments, motherboard 300 regulates the charging and discharging of the battery. It does this by monitoring battery levels. Wires 118 electrically connect the battery to motherboard 300 via junction 350. In some embodiments, junction 350 includes connection points 344 for connecting the wires to motherboard 300. Connection points 344 are then connected to a plurality of resistor chips 324. Resistor chips 324 are responsible for balancing the input of power for the battery by limiting the amount of current in the circuit and defuse current from diodes 322. Diodes 322 stabilize the current and limits fluctuations and temperature stability. In some embodiments, if the battery has reached full charge, diodes 322 also reroutes the current to resistor chips 324 and defuses the current overall.

In some embodiments, the motherboard includes a cell-balancing circuit configured to balance voltages among individual cells or cell groups. Cell balancing may be passive, active, resistive, switched-capacitor based, inductive, or performed using another balancing topology. The motherboard may monitor individual cell voltages, pack voltage, charge current, discharge current, and temperature to determine whether to enable charging, enable discharging, balance cells, enter a fault state, or provide a user alert.

In some embodiments, motherboard 300 also includes diodes 312, which are responsible for transient voltage suppression, via processor 330. Diodes 312 provide circuit protection by regulating against spikes in current charging and discharging. In some embodiments, motherboard 300 also includes resistors 332 for regulating wattage in the circuit and capacitors 334 for regulating voltage in the circuit, via processor 330. In addition, motherboard 300 can also include a plurality of resistors and capacitors 336 as extra layers of protection against failure.

In some embodiments, one other major function of motherboard 300 is safety with regard to overheating. Safety is important because over usage can lead to overheating, which can lead to melting of important electrical parts, which would mean irreparable damage, as well as a fire hazard around dangerous chemicals in the battery. Thus, in some embodiments, there are many safety mechanisms on motherboard 300 that work with processor 330 to ensure that the battery does not overheat and experience a thermal event. For example, transistor switches 316 are heavy duty switches that monitor the flow of power in and out of the battery. Resistor chips 318 act as current sensors and regulate the circuit to make sure the battery does not overcharge. Negative temperature coefficient (NTC) thermometer 346 also helps with safety regulation. NTC 346 wraps around and rests on the battery and physically monitors the heat. In some embodiments, NTC 346 includes a thermometer tip that is dipped in plastic to prevent moisture. In some embodiments, NTC 346 monitors the temperature to make sure it does not past a threshold temperature (e.g., 35 degrees Celsius). If the temperature passes the threshold, thermometer 346 increases resistance and alerts processor 330 to shut off the battery. In some embodiments, motherboard 300 also includes positive temperature coefficient (PTC) thermistor 340. PTC 340 also changes the resistance of the current and is used to determine if the circuit is too hot or too cold. The resistance in PTC 340 increases with heat, thereby slowing the current down. As temperature decreases, PTC 340 decreases resistance in the circuit, to increase current. Both PTC 340 and NTC 346 regulate current based on temperature. The difference is that they do it with opposite charges.

Temperature thresholds may include one or more warning thresholds, charge-inhibit thresholds, discharge-inhibit thresholds, recovery thresholds, or thermal-shutdown thresholds. The thresholds may differ for charging and discharging and may be selected based on battery chemistry, enclosure design, ambient environment, load current, certification requirements, or expected furniture duty cycle.

In some embodiments, motherboard 300 also includes diodes 320 for communicating, via processor 330, the remaining power left in the battery pack to LED lights 108. If the remaining power drops below a predetermined threshold, e.g. 10%, then diode 320 informs processor 330 to engage buzzer 352. Buzzer 352 emits a sound every time a user engages with the motorized furniture. In some embodiments, the sound is a single quick beep/chirp, a series of beeps or chirps, or a prolonged beep/chirp.

In some embodiments, motherboard 300 also includes Bluetooth processor 348. Bluetooth processor 348 works with processor 330 to shut off output from the battery. In some embodiments, this eliminates the problem of a constant power draw (a passive draw of around 37 milliAmps) from the battery even when the motors are not in use. While Bluetooth processor 348 itself will still have a small constant current (a passive draw of only around 14 microAmps), Bluetooth processor 348 essentially allows a user, via a mobile device, to be able to turn off the output almost completely for the battery. In some embodiments, this feature can be used to “override” the system when the system has determined that charging can be performed, such as the case when excess power is used to charge the battery when the battery is below a minimum charge threshold, e.g., 60%. In some embodiments, this feature can also be used to “override” the battery system when the system has determined that the battery should not be charged. For example, a user can use the Bluetooth function to force the system to charge the battery to max usable capacity (i.e., 80% chemical capacity) from a lower percentage that is above the minimum charge threshold but while the motor is not actually active. In addition, Bluetooth processor 348 will be able to tell a user what the remaining power is within the battery and allow the user to set an alert when the battery reaches a minimum threshold (e.g., 25%) to remind the user to recharge the battery. Last, in some embodiments, Bluetooth processor 348 is further configured to be able to tell how much time had passed since the last recharge. According to various embodiments, although the battery will have a charge of 80% of its actual capacity, the Bluetooth system will communicate to the user, via display on the mobile device, that the battery is 100% charged. This will prevent overcharging of the battery under most circumstances. In such embodiments, this feature will also discourage users from forcibly overcharging the battery by overriding any pre-set limits. Similarly, according to various embodiments, although the battery will actually have a charge of 20%, the Bluetooth system will show to the user a charge of 0%. In some embodiments, the minimum actual percentage is a different minimum threshold number, e.g., 10%, rather than 20%. However, for the purpose of ease of explanation, the minimum threshold number of 20% will be used to illustrate this example. This feature serves to discourage users from actually letting the battery drain to 0%, which is very detrimental to battery life. In such embodiments where actual 80% is shown as 100% and actual 20% is shown as 0%, any displayed percentages between 0% and 100% is calibrated/prorated from the actual usable 20% to 80% range. For example, when the battery is actually at 26% capacity, the Bluetooth displayed battery life will be 10%, because 6% is one tenth of the usable 60% range.

Although Bluetooth communication is described as one example, the wireless processor may support Bluetooth Low Energy, Wi-Fi, Zigbee, Thread, Matter, NFC, cellular, proprietary radio, infrared, or another communication protocol. In some embodiments, wireless control allows a user or service technician to disable output, enable storage mode, view state of charge, view cycle count, view time since last charge, receive fault alerts, or update firmware.

FIG. 3B illustrates a backside view of regulatory motherboard 300. In some embodiments, the backside has a base 360 which is different from base 302 because the backside base 360 has a different printed circuit on it. Backside 360 includes a switch 372 that includes power button 109 for turning on LED lights 108. In some embodiments, switch 372 can also put the battery pack in demo mode if pressed and held for a threshold number of seconds (e.g., 5 seconds). In some embodiments, demo mode engages buzzer 352 to beep every time a user engages with the furniture, rather than just beeping when the battery drops below a predetermined threshold.

In some embodiments, the backside of motherboard 300 also includes LED lights 108. In some embodiments, LED lights 108 include five separate LED lights. In some embodiments, four of the five LED lights 362, 364, 366, and 368 are green. In some embodiments, one of the LED lights 370 is red. One example of how LED lights 108 display a scale of battery life is as follows: LED light 362 turns on only when the battery is charged at 100% usable capacity (80% actual capacity). LED light 364 turns on only when the battery is charged over 75% usable capacity (65% actual capacity). LED light 366 turns on only when the battery is charged over 50% usable capacity (50% actual capacity). LED light 368 turns on only when the battery is charged over 25% usable capacity (35% actual capacity). Last, LED light 370 only turns on when the battery is charged under 25% usable capacity but more than 0% usable capacity (20% actual capacity). If the battery is charged under 25% usable but over 10% usable, LED light 370 will be a constant red. If the battery is charged under 10% usable, then LED light 370 will blink red. The previous example is just one example of how the lights can be configured to indicate battery life. Other configurations are also possible as long as the LED lights 108 can be turned on by power button 109 and show a scale indication of battery life.

User alerts may be provided through LEDs, a buzzer, vibration, a furniture control panel, a mobile application, a wireless notification, a service diagnostic tool, or combinations thereof. The alerts may indicate battery state of charge, low battery, charging active, charge complete, bypass active, thermal fault, adapter fault, cell imbalance, service mode, shipping mode, or demo mode.

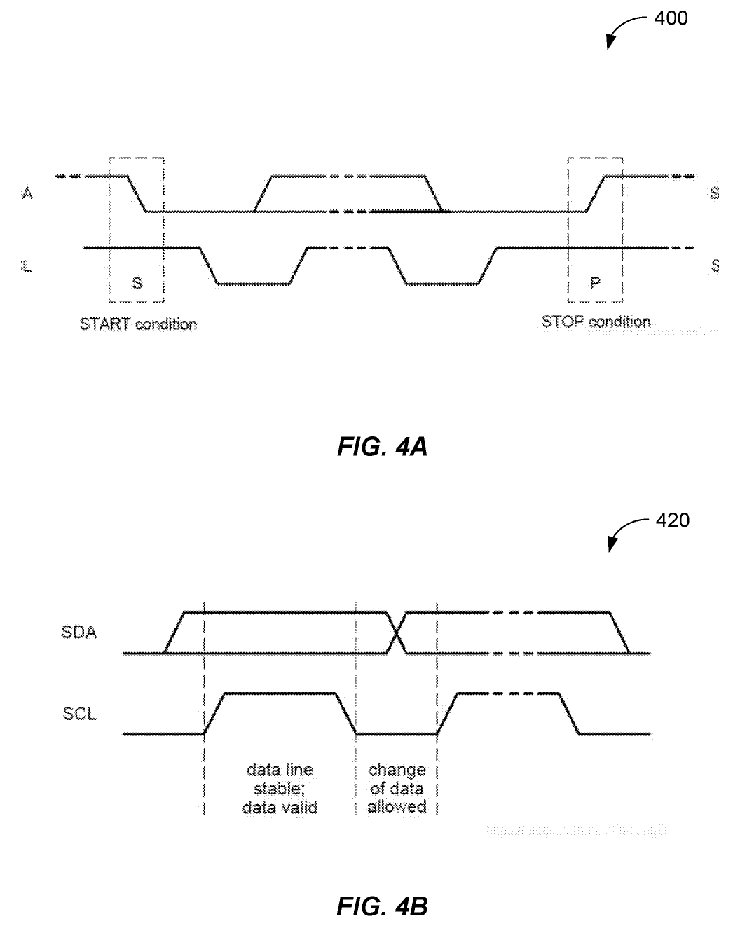

FIG. 4A illustrates an example 400 of signal conditions for communication lines, in accordance with some embodiments. In some embodiments, the communication lines correspond to a Serial Data Line (SDA) and a Serial Clock Line (SCL) of an Inter-Integrated Circuit (I2C) bus used for communication between a controller, such as MCU 330, and one or more peripheral components, such as an analog front end.

In some embodiments, the I2C communication shown in FIG. 4A is used to transmit operational data related to battery management, including battery cell voltage, current measurements, temperature data, and status information. This data may be used by the controller to determine a state of charge of the battery and to control charging and discharging operations.

As illustrated, a start condition is generated when the SDA line transitions from a high state to a low state while the SCL line remains high. In some embodiments, this start condition initiates a communication sequence in which the controller requests measurement data from the analog front end.

During the communication sequence, data is transmitted in a series of bits synchronized by the SCL line. In some embodiments, the transmitted data includes voltage measurements used to determine whether the battery has reached an upper charge threshold or has fallen below a recharge threshold.

A stop condition is generated when the SDA line transitions from a low state to a high state while the SCL line remains high, thereby terminating the communication sequence. In some embodiments, the controller uses the received data to generate control signals that activate or deactivate a charge switch or a discharge switch.

FIG. 4B illustrates another example of signal conditions for communication lines, in accordance with some embodiments. In some embodiments, FIG. 4B illustrates timing relationships between the SDA and SCL lines during data transmission.

As shown, data on the SDA line remains stable during periods when the SCL line is high, and changes in data occur when the SCL line is low. This timing relationship ensures reliable communication between the controller and peripheral components.

In some embodiments, the communication illustrated in FIG. 4B is used to convey control and status information associated with battery management operations. For example, data transmitted over the I2C bus may indicate that a battery voltage has reached a threshold value, prompting the controller to disable a charge MOSFET or enable a recharge cycle.

In some embodiments, communication over the I2C bus enables the controller to coordinate operation of multiple components, including charge management circuitry, discharge switching circuitry, and bypass control elements. By synchronizing data transfer with clock signals, the system ensures accurate monitoring and control of battery conditions.

In some embodiments, the communication protocol supports repeated start conditions, acknowledgements, and multi-byte data transfers, allowing the controller to continuously monitor battery conditions and dynamically adjust system behavior in response to changes in load demand, external power availability, and battery state of charge.

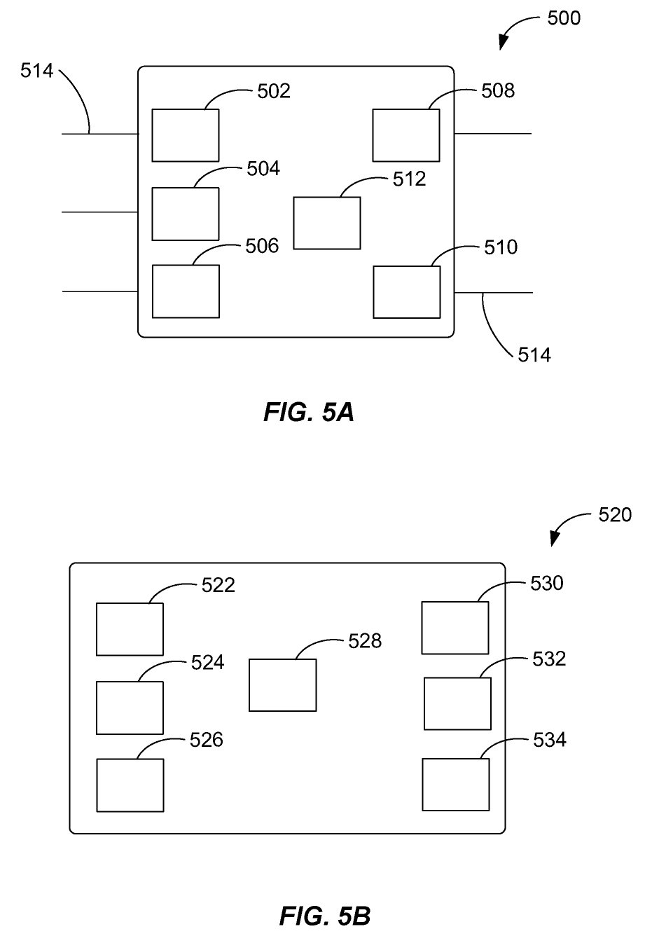

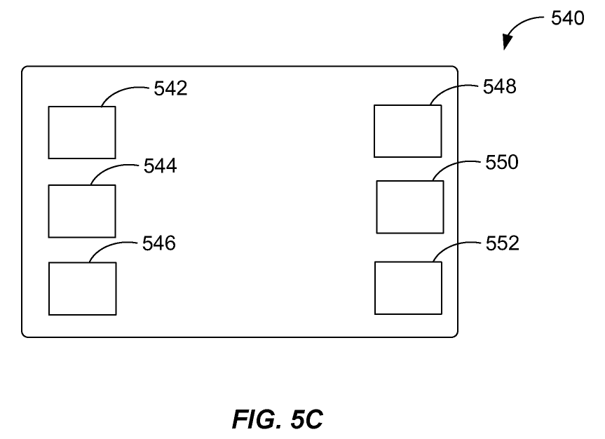

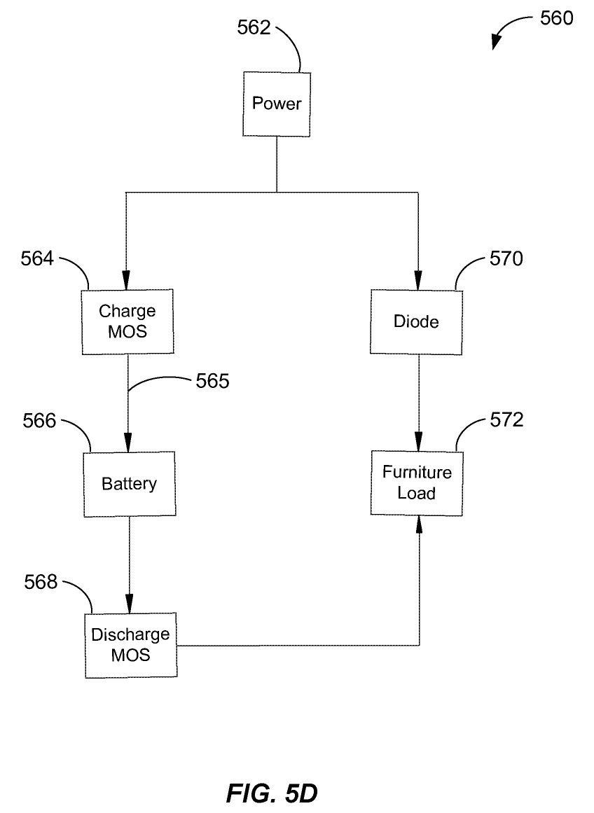

FIGS. 5A-5D illustrate example component parts, in accordance with some embodiments. FIG. 5A illustrates an example analog front end 500, in accordance with some embodiments. The analog front end 500 of FIG. 5A may include voltage-sense inputs 502, current-sense inputs 504, temperature-sense inputs 506, cell-balancing outputs 508, protection comparators 512, communication pins 514, and gate-control outputs 510. FIG. 5B illustrates an example MCU 520, in accordance with some embodiments. The MCU 520 of FIG. 5B may execute firmware for state-of-charge estimation 522, adapter detection 524, bypass control 526, charge control 528, discharge control 530, user-interface control 532, and fault handling 534. FIG. 5C illustrates an example charge management 540, in accordance with some embodiments. The charge-management circuit 540 of FIG. 5C may regulate charge current 542, charge voltage 544, pre-charge operation 546, termination 548, recharge 550, and fault recovery 552. FIG. 5D illustrates an example circuit connection diagram 560, in accordance with some embodiments. Circuit connection diagram 560 of FIG. 5D may include power 562, charge MOS 564, battery 566, discharge MOS 568, diode 570, and furniture load 572. As shown in FIG. 5D, external power 562 is coupled to both charge MOS 564 and diode 570 in parallel. Charge MOS 564 may selectively connect or disconnect the battery cells from a charging path 565. Discharge MOS 568 may selectively connect or disconnect the battery cells 566 from the furniture load 572. Bypass diode 570 may provide a unidirectional adapter-to-load path that allows the furniture load to be powered while reducing or preventing reverse current into the adapter or battery discharge path.

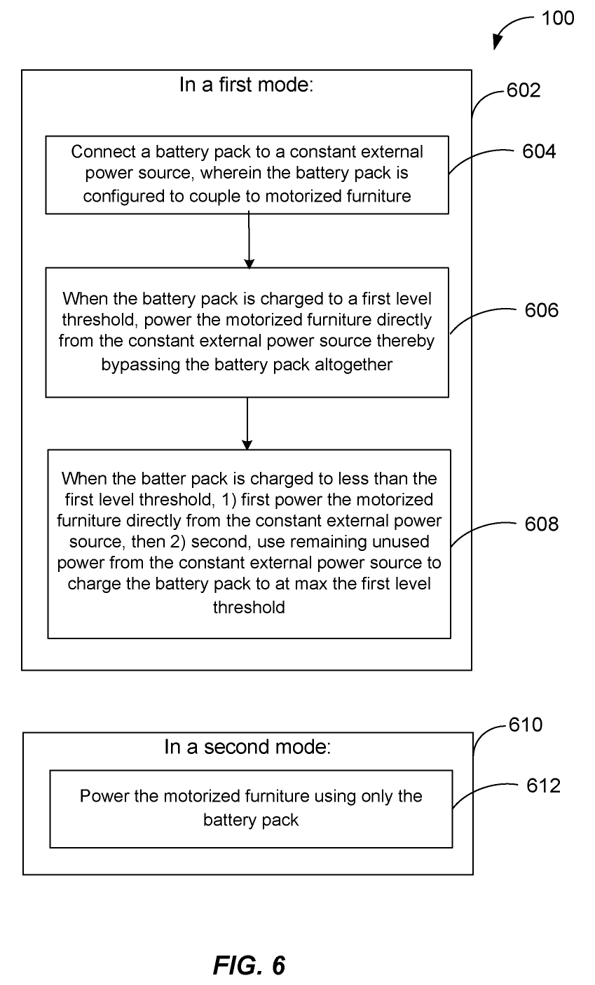

FIG. 6 illustrates an example method for operating motorized furniture, in accordance with some embodiments. Method 600 includes two modes, a first mode 602 and a second mode 610. First mode 602 is when the motorized furniture is connected directly to an external power source, e.g., plugged into a wall outlet. Second mode 610 is when the motorized furniture is operating on battery power only. In first mode 602, a battery pack is connected (604) to a constant external power source, wherein the battery pack is configured to couple to motorized furniture. Then, when the battery pack is charged to a first level threshold, the motorized furniture is powered (606) directly from the constant external power source thereby bypassing the battery pack altogether. Last, at step 608, when the batter pack is charged to less than the first level threshold, 1) first the motorized furniture is powered directly from the constant external power source, then 2) second, any remaining unused power from the constant external power source is used to charge the battery pack to at max the first level threshold. In second mode 610, the motorized furniture is powered (612) using only the battery pack.

In some embodiments, method 600 further includes detecting presence of the external power source, disabling a battery discharge switch in response to detecting the external power source, enabling the bypass path, determining whether load demand is below available adapter capacity, enabling a charge switch when surplus adapter capacity is available and the battery state of charge is below the upper charge threshold, disabling the charge switch when the upper charge threshold is reached, and maintaining the battery in a dormant monitored state while continuing to power the furniture load from the external power source.

In some embodiments, method 600 further includes monitoring temperature, current, voltage, cell imbalance, or short-circuit conditions and disabling charging, disabling discharging, sounding an alarm, displaying a warning, or transmitting a wireless notification in response to a detected fault.

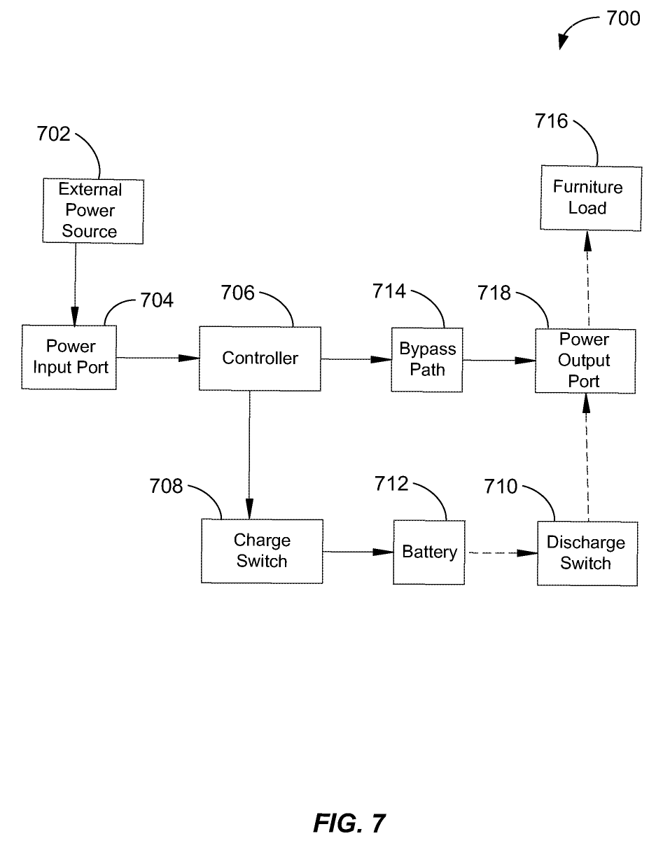

FIG. 7 illustrates a block diagram of an example power path architecture, in accordance with some embodiments. As shown, system 700 includes an external power source 702, such as an AC-DC adapter, electrically coupled to a power input port 704 of a battery pack. Power input port 704 is configured to receive electrical energy from external power source 702 and distribute the electrical energy to one or more internal components of system 700.

In some embodiments, power input port 704 is electrically coupled to controller 706. Controller 706 may include a microcontroller unit (MCU), an analog front end (AFE), and/or other control circuitry configured to monitor and regulate operation of system 700. In some embodiments, controller 706 is configured to detect the presence of external power source 702, determine a state of charge of battery cells 712, monitor temperature, and control switching elements within the system.

System 700 further includes a charge switch 708 electrically coupled between power input port 704 and battery cells 712. In some embodiments, charge switch 708 comprises a metal-oxide-semiconductor field-effect transistor (MOSFET) or other controllable switching device configured to selectively permit or prevent charging of battery cells 712. Controller 706 is configured to control charge switch 708 based on one or more conditions, including battery state of charge, temperature, and availability of surplus power.

System 700 also includes a discharge switch 710 electrically coupled between battery cells 712 and power output port 718. In some embodiments, discharge switch 710 comprises a MOSFET or similar switching device configured to selectively permit or prevent discharge of battery cells 712 to a load. Controller 706 may disable discharge switch 710 when external power source 702 is present to inhibit battery discharge.

Battery cells 712 may include one or more rechargeable electrochemical cells arranged in series, parallel, or a combination thereof. In some embodiments, battery cells 712 are lithium-ion or lithium-polymer cells, although other chemistries may be used.

System 700 further includes a bypass path 714 electrically coupled between power input port 704 and power output port 718. In some embodiments, bypass path 714 includes a diode, an ideal diode circuit, a MOSFET-based power path circuit, or another unidirectional or controllable conduction path. Bypass path 714 is configured to allow electrical energy from external power source 702 to be delivered directly to furniture load 716 without requiring discharge of battery cells 712.

Furniture load 716 represents one or more electrical loads of powered furniture, such as motors, actuators, lighting elements, heating elements, or charging ports. Power output port 718 is configured to deliver electrical energy to furniture load 716.

In operation, when external power source 702 is present, controller 706 may disable discharge switch 710 and permit electrical energy to flow from power input port 704 to furniture load 716 through bypass path 714. In some embodiments, if the power demand of furniture load 716 is less than the available power from external power source 702, controller 706 may enable charge switch 708 to allow surplus energy to charge battery cells 712. When battery cells 712 reach an upper charge threshold, controller 706 may disable charge switch 708, thereby maintaining the battery in a non-charging state while the furniture load continues to be powered by external power source 702.

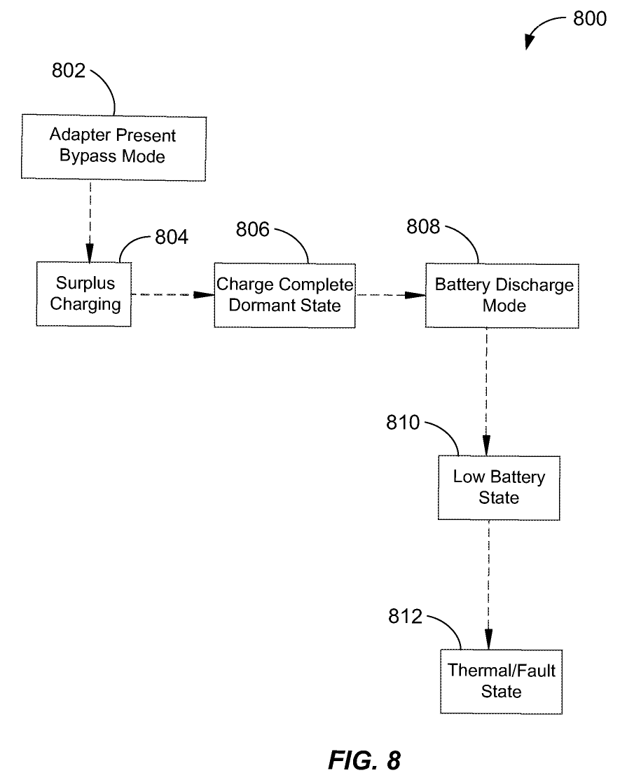

FIG. 8 illustrates an example state diagram for power management control, in accordance with some embodiments. System 800 includes a plurality of operational states that govern how electrical energy is distributed between an external power source and a battery.

In some embodiments, system 800 includes an adapter-present bypass state 802. In this state, an external power source is detected and electrical energy is routed directly to a load through a bypass path. In some embodiments, battery discharge is disabled in this state.

System 800 may further include a surplus charging state 804. In this state, external power is available and exceeds the power demand of the load. In some embodiments, surplus power is used to charge the battery while the load continues to be powered by the external power source.

System 800 may also include a charge-complete dormant state 806. In this state, the battery has reached an upper charge threshold. Charging is disabled, and the battery is maintained in a monitored, non-charging condition while the load is powered by the external power source.

In some embodiments, system 800 includes a battery discharge state 808. This state occurs when the external power source is not available. In this state, the battery supplies power to the load through a discharge path.

System 800 may further include a low battery state 810. In this state, the battery state of charge has fallen below a predetermined threshold. In some embodiments, user alerts, such as LED indicators or audible signals, may be triggered in this state.

System 800 may also include a thermal or fault state 812. In this state, a fault condition such as over-temperature, over-current, short circuit, or abnormal voltage is detected. In response, system 800 may disable charging, disable discharging, or otherwise isolate components to prevent damage or unsafe conditions.

Transitions between states may be based on detection of an external power source, battery state of charge thresholds, temperature measurements, current levels, or fault conditions. In some embodiments, controller 706 (FIG. 7) manages transitions between these states.

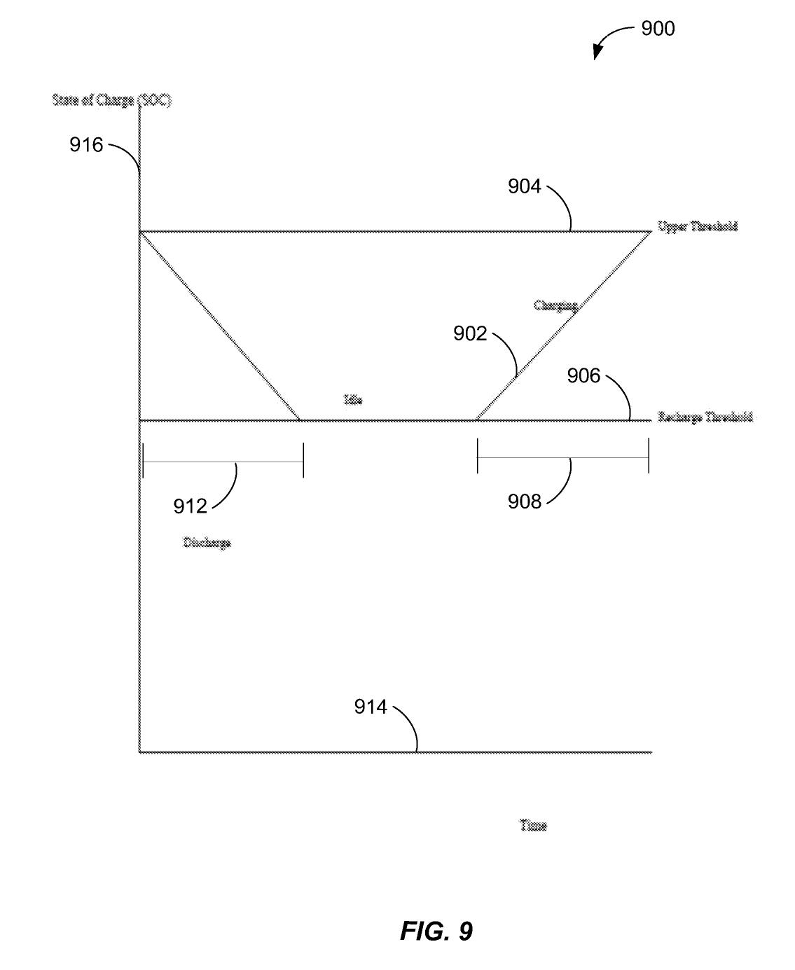

FIG. 9 illustrates an example charge and discharge profile showing threshold-based hysteresis behavior, in accordance with some embodiments. Graph 900 includes a vertical axis 916 representing state of charge (SOC) and a horizontal axis 914 representing time.

Curve 902 represents the state of charge of a battery over time. In some embodiments, the battery is discharged during use when an external power source is not present. As the battery discharges, the state of charge decreases toward a recharge threshold 906.

Recharge threshold 906 represents a lower threshold at which charging is initiated when an external power source becomes available. In some embodiments, recharge threshold 906 corresponds to approximately 60% usable capacity, although other values may be used.

Upper charge threshold 904 represents a maximum charge level for the battery. In some embodiments, upper charge threshold 904 corresponds to approximately 80% of total battery capacity, which may be presented to a user as 100% usable capacity. When the battery reaches upper charge threshold 904, charging is terminated.

Charging region 908 represents a time period during which the battery is actively charged. In some embodiments, charging occurs when the state of charge is below upper charge threshold 904 and an external power source is available.

Discharge region 912 represents a time period during which the battery supplies power to the load. This occurs when the external power source is unavailable.

The difference between upper charge threshold 904 and recharge threshold 906 provides hysteresis, which reduces frequent switching between charging and non-charging states. In some embodiments, hysteresis improves battery longevity and system stability by minimizing unnecessary charge cycles.

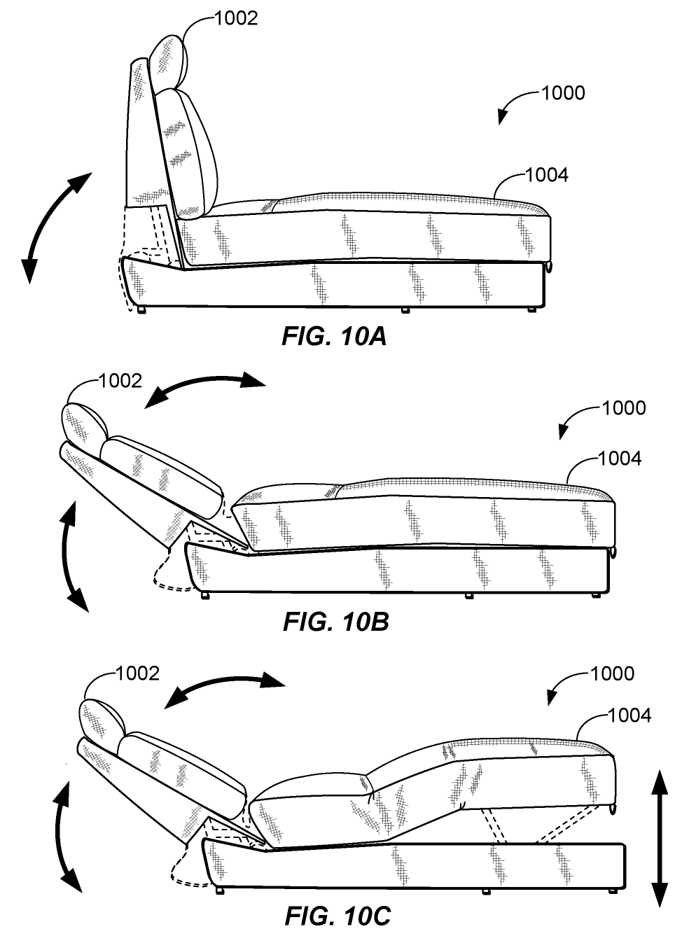

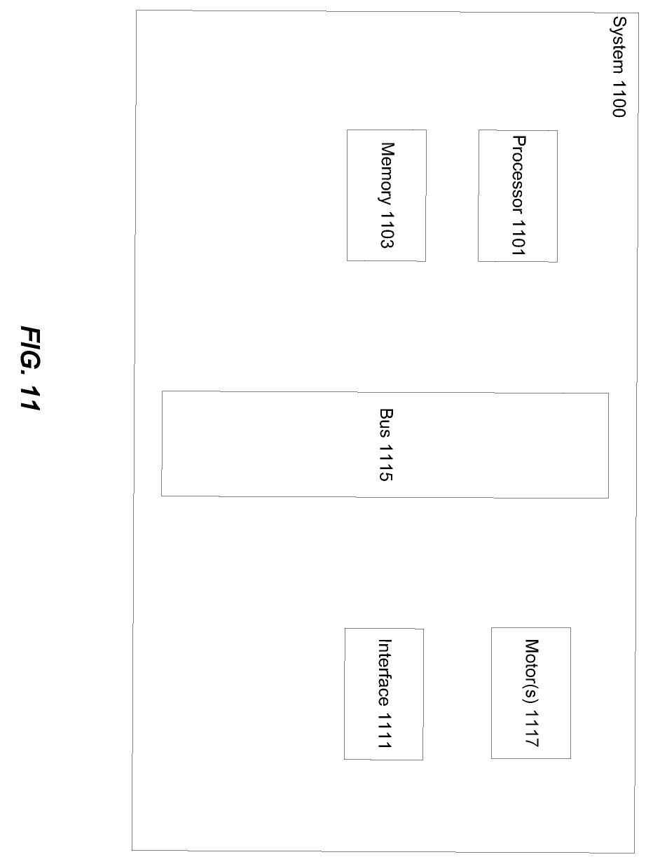

FIGS. 10A-10C illustrate an example of motorized furniture functions, in accordance with some embodiments. In some embodiments, battery pack 100 can be used to power motorized furniture 1000. FIG. 10A shows motorized movement in the backrest 1002, which allows the backrest to recline, as shown in FIG. 10B. FIG. 10C shows motorized function in the leg rest 1004, allowing the leg rest 1004 to elevate into a zero gravity position.

Motorized furniture 1000 may include a sofa, recliner, sectional, theater seat, lift chair, adjustable bed, hospital bed, massage chair, desk, table, crib, lounge chair, or other furniture having one or more electrical loads. The electrical loads may include motors, actuators, massage devices, heating elements, cooling devices, lighting, speakers, control panels, USB charging ports, wireless charging coils, sensors, or embedded electronic devices.

FIG. 11 illustrates one example of an electronic system, in accordance with some embodiments. According to particular embodiments, a system 1100 suitable for implementing particular embodiments of the present disclosure includes a processor 1101, a memory 1103, an interface 1111, and a bus 1115 (e.g., a PCI bus or other interconnection fabric) and operates battery packs and/or furniture. When acting under the control of appropriate software or firmware, the processor 1101 is responsible for implementing applications for regulating battery levels, operating motorized functions, and interacting with a user. Various specially configured devices can also be used in place of a processor 1101 or in addition to processor 1101. The interface 1111 is typically configured to send and receive data packets or data segments over a network or through a wireless connection, such as Bluetooth. System 1100 can also include one or more motors 1117 electrically connected to processor 1101 for moving pieces of furniture.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 1100 is an electronic system configured to regulate a battery pack, operate furniture, or some combination of both. The electronic system may include one or more hardware elements as shown in FIG. 11. In some implementations, one or more of the electronic system components may be virtualized. For example, parts of a physical electronic system may be configured in a localized or cloud environment. Although a particular electronic system is described, it should be recognized that a variety of alternative configurations are possible. For example, the modules may be implemented on another device connected to the electronic system.

The battery packs presented in the present disclosure provide many benefits over the current art. For example, the battery packs disclosed herein have much better battery life. In addition, the systems are much more efficient in terms of power consumption. In addition, the scale LED allows a user to see the volume of power remaining in the battery, which is not currently available in furniture battery packs. In some embodiments, the buzzer notifies the user upon interaction with motor the battery level reaching a minimum critical threshold level or less and needs to be recharged. In some embodiments, the Bluetooth processor allows a user to turn off the battery pack output, thereby reducing the constant power draw from the battery even when the motorized furniture is not in use and prolonging the life of the battery pack. Last, the battery packs have the capability to disable the output cable while the battery pack is charging. The battery packs may also disable the output cable while the battery pack is charging, which can improve safety, reduce heat generation, reduce simultaneous charge/discharge stress, and extend battery life.

While the present disclosure has been particularly shown and described with reference to specific embodiments thereof, it will be understood by those skilled in the art that changes in the form and details of the disclosed embodiments may be made without departing from the spirit or scope of the present disclosure. It is therefore intended that the present disclosure be interpreted to include all variations and equivalents that fall within the true spirit and scope of the present disclosure. Although many of the components and processes are described above in the singular for convenience, it will be appreciated by one of skill in the art that multiple components and repeated processes can also be used to practice the techniques of the present disclosure.

What is claimed is:

1. A battery pack for powered furniture, the battery pack comprising:
a rechargeable battery;
a power input configured to receive power from an external power source;
a power output configured to supply power to at least one electrical load of the powered furniture;
a charge switch coupled between the power input and the rechargeable battery;
a discharge switch coupled between the rechargeable battery and the power output;
a bypass path coupled between the power input and the power output; and
control circuitry configured to:
detect presence of the external power source at the power input;
in response to detecting the external power source, disable the discharge switch and supply power from the external power source to the power output through the bypass path;
enable the charge switch when a state of charge of the rechargeable battery is below a recharge threshold; and
disable the charge switch when the state of the charge reaches an upper charge threshold such that the rechargeable battery is electrically isolated from supplying current to the load while the external power source powers the load through the bypass path.

2. The battery pack of claim 1, wherein the upper charge threshold is approximately 80% of total battery capacity.

3. The battery pack of claim 1, wherein the recharge threshold is approximately 60% usable capacity.

4. The battery pack of claim 1, wherein the bypass path includes a diode.

5. The battery pack of claim 1, wherein the bypass path includes an ideal diode circuit or MOSFET circuit.

6. The battery pack of claim 1, wherein the controller communicates with an analog front end using I2C.

7. The battery pack of claim 1, wherein the battery pack includes a Bluetooth or wireless communication module.

8. The battery pack of claim 1, wherein the controller disables output in response to a wireless command.

9. The battery pack of claim 1, wherein the battery pack includes LED state-of-charge indicators or a buzzer configured to indicate a low-battery condition.

10. The battery pack of claim 1, wherein power is supplied to the load from the external power source without passing through the rechargeable battery.

11. The battery pack of claim 1, wherein the controller disables charging in response to an over-temperature condition.

12. The battery pack of claim 1, wherein the furniture load includes a reclining actuator, lift actuator, massage device, heating element, lighting element, USB charging port, or wireless charging coil.

13. The battery pack of claim 1, wherein the controller maintains the rechargeable battery in a dormant monitored state after the upper charge threshold is reached.

14. The battery pack of claim 1, wherein the state of charge is determined based on average cell voltage.

15. The battery pack of claim 1, wherein the battery pack prevents simultaneous discharge of the rechargeable battery and powering of the furniture load from the external power source.

16. A powered furniture system, the system comprising:
an article of furniture;
at least one motorized actuator configured to move a portion of the article of furniture; and
a battery pack electrically coupled to the at least one motorized actuator, the battery pack comprising a rechargeable battery, an adapter input, a load output, a bypass circuit, and a controller configured to prioritize power from an external adapter to the at least one motorized actuator through the bypass circuit while inhibiting discharge of the rechargeable battery when the external adapter is present.

17. The powered furniture system of claim 16, wherein the portion of the article of furniture includes a reclining actuator, lift actuator, massage device, heating element, lighting element, USB charging port, or wireless charging coil.

18. The powered furniture system of claim 16, wherein the controller disables output in response to a wireless command.

19. The powered furniture system of claim 16, wherein the battery pack prevents simultaneous discharge of the rechargeable battery and powering of the furniture load from the external power source.

20. A method of operating powered furniture, the method comprising:
detecting, by control circuitry of a battery pack, that an external power source is connected to a power input of the battery pack;
disabling a discharge path from a rechargeable battery of the battery pack to a furniture load;
supplying power from the external power source to the furniture load through a bypass path;
determining that a state of charge of the rechargeable battery is below a recharge threshold;
enabling a charge path to charge the rechargeable battery using surplus power from the external power source; and
disabling the charge path when the rechargeable battery reaches an upper charge threshold below a full chemical capacity of the rechargeable battery.
